(19) United States
(12) Patent Application Publication
(10) Pub. No.: US 2015/0052451 A1
(43) Pub. Date: Feb. 19, 2015

(54) REAL TIME TEXT MESSAGE SYSTEM

(71) Applicant: Carlos Cueto, Miami Lakes, FL (US)

(72) Inventor: Carlos Cueto, Miami Lakes, FL (US)

(21) Appl. No.: 14/459,303

(22) Filed: Aug. 13, 2014

Related U.S. Application Data
(60) Provisional application No. 61/865,253, filed on Aug. 13, 2013.

(51) Int. Cl. H04M 1/725; H04W 4/14; G06F 3/0488; G06F 3/0484; G06F 3/0482

(52) U.S. Cl. CPC H04M 1/72552; G06F 3/04842; G06F 3/0482; G06F 3/04886; H04W 4/14
USPC 715/752

(57) ABSTRACT

A mobile text messaging application on a mobile computing device communicatively coupled to a communications network is disclosed. The mobile application includes an initiation module configured for sending a validation request to a central server, wherein said validation request includes a unique identifier for the user, and receiving a validation, as well as a validated list of text messaging recipients, a transmission module configured for storing a unique identifier for each of the one or more text messaging recipients selected from the validated list, transmitting a keyboard stroke, as well as the unique identifier for the user and all recipients selected, to the central server, without requiring any command from the user to send the keyboard stroke, and a receiving module configured for receiving a keyboard stroke displaying it inline in the graphical user interface.

### CROSS-REFERENCE TO RELATED APPLICATIONS

This patent application claims priority to provisional patent application No. 61/865,253 filed Aug. 13, 2013 and entitled “Real Time Text Message System.” The subject matter of provisional patent application No. 61/865,253 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The present invention relates generally to the field of telecommunications and, more specifically, the present invention relates to the field of real time text messaging over a telecommunications network.

### BACKGROUND

Text messaging, or texting, is the act of typing and sending a brief, electronic message between two or more mobile phones or computing devices over a communications network. The term refers to messages sent using the Short Message Service (SMS), as well as messages containing image, video, and sound content (known as MMS messages). Today, text messaging is the most widely used mobile data service, with the grand majority of all mobile phone users worldwide, or 2.4 billion out of 3.3 billion phone subscribers, being active users of the Short Message Service. Text messaging is most often used between private mobile phone users, as a substitute for voice calls in situations where voice communication is impossible or undesirable. The use of text messaging for business purposes has further grown significantly in recent years.

One common problem with commercially available text messaging applications, however, is latency. Typically, a user enters a text message into a text messaging application and then presses a send button to transfer the message to the recipient. While the user is writing the message, the recipient simply waits for the message to be sent. At times, the sender of the message may take a significant amount of time to write, revise and send the message, while the recipient waits. This can be burdensome and time consuming for the recipient. The fast pace of communications today requires a faster method of sending a brief, electronic message between mobile phones or computing devices over a communications network.

Therefore, what is needed is a system and method for improving upon the problems with the prior art, and more particularly for a more efficient way of communicating brief, electronic messages over a communications network.

### SUMMARY

According to the aspects illustrated herein, a mobile text messaging application on a mobile computing device communicatively coupled to a communications network is disclosed. The mobile application includes a graphical user interface for receiving input from a user of the mobile application; an initiation module configured for: receiving a command from the user via the graphical user interface, the command for sending a validation request to a central server; sending a validation request to the central server over the communications network, in response to receiving said command, wherein said validation request includes a unique identifier for the user; and receiving a validation, as well as a validated list of text messaging recipients, from the central server over the communications network, wherein each recipient in the validated list has received a validation, and wherein the validated list includes a unique identifier for each recipient; a transmission module configured for: receiving a selection from the user via the graphical user interface, the selection comprising one or more text messaging recipients from the validated list; storing a unique identifier for each of the one or more text messaging recipients selected from the validated list; detecting the input of a single keyboard stroke by the user in the graphical user interface and transmitting the keyboard stroke, as well as the unique identifier for the user and a unique identifier for each of the one or more text messaging recipients selected from the validated list, to the central server over the communications network, without requiring any command from the user to send the keyboard stroke; and a receiving module configured for: receiving a keyboard stroke from the central server over the communications network; and displaying the keyboard stroke, and each subsequent keyboard stroke received, inline in the graphical user interface of the mobile computing device.

This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

### BRIEF DESCRIPTION OF THE DRAWINGS

The accompanying drawings, which are incorporated in and constitute a part of this disclosure, illustrate various example embodiments. In the drawings:

FIG. 1 is a block diagram illustrating a network architecture of a system for communicating real time text messages over a communications network, in accordance with one embodiment.

FIG. 2 is a block diagram illustrating the data flow for a system for communicating real time text messages over a communications network, in accordance with one embodiment.

FIG. 3 is a block diagram further illustrating the data flow for a system for communicating real time text messages over a communications network, in accordance with one embodiment.

FIG. 4 is a block diagram of a system including an example computing device and other computing devices.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

The disclosed embodiments improve upon the problems with the prior art by providing a system and method for allowing the quick and easy transmission of text message data over a telecommunications network, in real time. The term real time, in telecommunications and computing, refers to the time delay introduced by automated data processing or network transmission between the occurrence of an event and the use of the processed data, such as for display. In the disclosed embodiments, the only delay introduced between the typing of a keystroke in a sender's computer and the display of the keystroke in a recipient's computer is the time necessary for the keystroke to travel between the two computers, which is a negligible time delay. Further, the disclosed embodiments allow a recipient of a text message to see a sender's keystrokes as they occur in real time, including backspaces, deletions, corrections, copies, pastes and the like. This provides a recipient with a rare window into the message generation process of a sender of a text message. The disclosed embodiments thereby allow individuals to utilizes well-known tools, such as SMS text and web browsers, on their respective mobile computing devices (cell phones, smart phones, tablet computers, etc.) to communicate text message data in a fast and user-friendly manner.

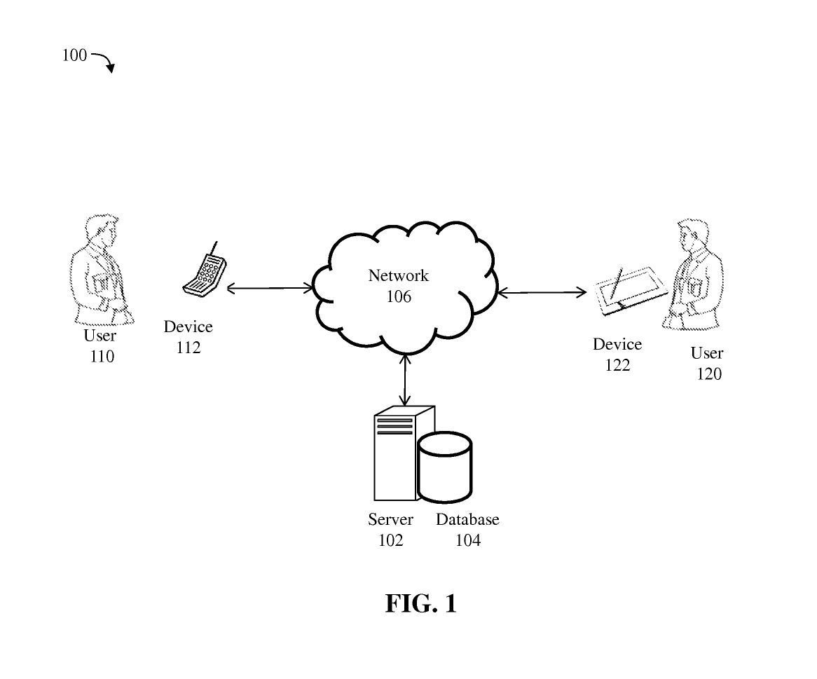

Referring now to the drawing figures in which like reference designators refer to like elements, there is shown in FIG. 1 an illustration of a block diagram 100 showing the network architecture of a system for facilitating real time text messaging over a communications network.

A prominent element of FIG. 1 is the server 102 associated with repository or database 104 and further coupled with network 106, which can be a circuit switched network, such as the Public Service Telephone Network (PSTN), or a packet switched network, such as the Internet or the World Wide Web, the global telephone network, a cellular network, a mobile communications network, or any combination of the above. Server 102 is a central controller or operator for functionality of the disclosed embodiments, namely, facilitating real time text messaging over a communications network 106.

FIG. 1 includes stationary or mobile computing devices 112 and 122, which may be smart phones, mobile phones, tablet computers, handheld computers, laptops, or the like. Computing devices 112 and 122 correspond to users 110 and 120, who may be any user of a computing device.

FIG. 1 further shows that server 102 includes a database or repository 104, which may be a relational database comprising a Structured Query Language (SQL) database stored in a SQL server. Devices 112, 122 may also each include their own database. The repository 104 serves data from a database, which is a repository for data used by server 102 and devices 112, 122 during the course of operation of the disclosed embodiments. Database 104 may be distributed over one or more nodes or locations that are connected via network 106.

The database 104 may include a user record for each user 110 or 120. A user record may include: contact/identifying information for the user (name, address, telephone number(s), email address, date of birth, social security number, a photo, etc.), a user address identifier (such as an email address, text message address, UseNet address, mobile phone number, etc), etc. A user record may also include a unique identifier for each user, a residential address for each user, the current location of each user (based on location-based services from the user's mobile computer) and demographic data for each user, such as age, sex, income data, race, color, marital status, etc.

A user record may also include a list of text message or chat partners or friends of said user identified by the user record. Each chat partner or friend may be identified in the user record by any of the above information for a user record, such by name, address, telephone number(s), email address, date of birth, social security number, a photograph, a user address identifier (such as an email address, text message address, UseNet address, mobile phone number, etc), a unique identifier, a residential address, etc.

FIG. 1 shows an embodiment of the present invention wherein networked computing devices 112, 122 interact with server 102 and repository 104 over the network 106 in the course of engaging in real time text messaging activities. Server 102 includes a software engine that delivers applications, data, program code and other information to networked computing devices 112, 122. It should be noted that although FIG. 1 shows only the networked computers 102, 112, 122, the system of the disclosed embodiments supports any number of networked computing devices connected via network 106. Further, server 102 and devices 112, 122 include program logic such as computer programs, mobile applications, executable files or computer instructions (including computer source code, scripting language code or interpreted language code that may be compiled to produce an executable file or that may be interpreted at run-time) that perform various functions of the disclosed embodiments.

Note that although server 102 is shown as a single and independent entity, in one embodiment, the functions of server 102 may be integrated with another entity, such as one of the devices 112, 122. Further, server 102 and its functionality, according to a preferred embodiment, can be realized in a centralized fashion in one computer system or in a distributed fashion wherein different elements are spread across several interconnected computer systems.

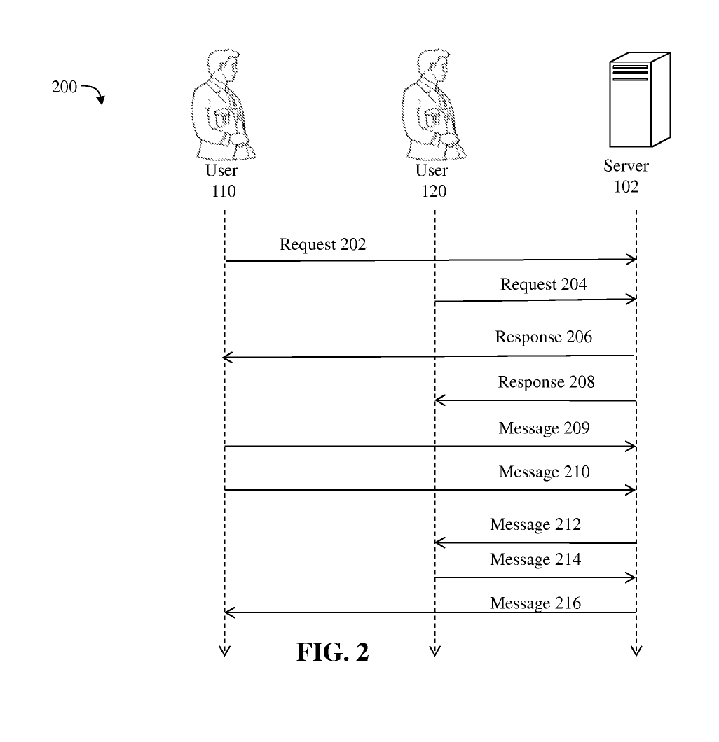

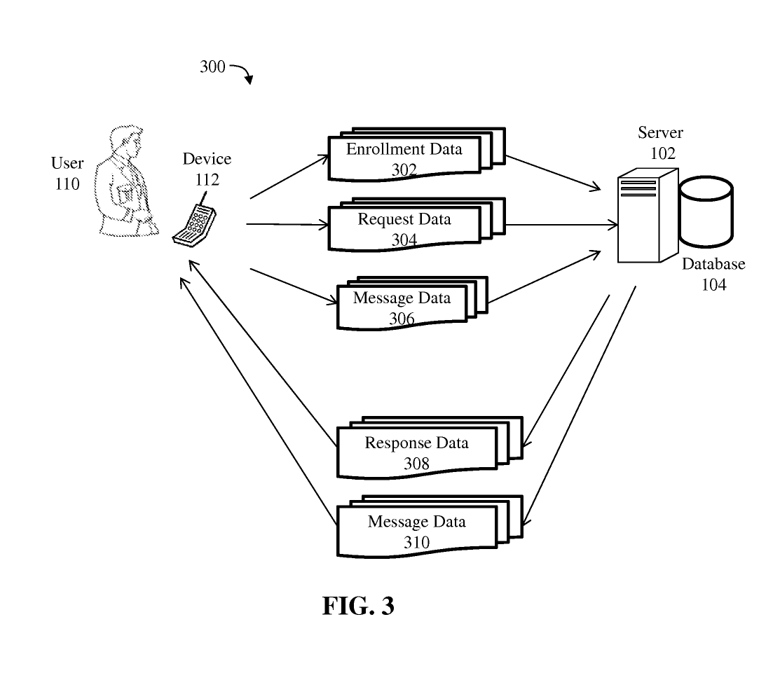

The process of for facilitating real time text messaging over a communications network 106 will now be described with reference to FIGS. 2 through 3 below, which provide block diagrams 200 and 300 illustrating the data flow for a system for facilitating real time text messaging over a communications network, in accordance with one embodiment.

In one optional alternative, the process may begin with each user 110, 120 executing an application (such as a mobile app running on the device 112 or 122), so as to begin the process of enrolling with server 102 to be able to use the real time text messaging system. Enrolling entails the user 110, 120 entering any data that would be stored in a user record, as defined above. The users 110, 120 may interact with the application via the graphical user interface (GUI) of the application, wherein the users may enter information into the GUI by pressing certain buttons of the devices 112, 122, interacting with the touch pads or touch-screens of the device 112, 122, giving speech commands to devices 112, 122, typing information into the GUI of the application via devices 112, 122, or any combination of the above.

The application then sends any data 302 entered by users 110, 120 to server 102 over the communications network 106, such as via HTTP. A server application running on the server 102 receives the data 302 entered by users 110, 120. A server application running on the server 102 takes the data 302 and, in response, creates a user record for each user 110, 120, using the data 302 entered by each user. In this step, the server application may further assign each user record a unique identifier and send this unique identifier to each user, wherein the application running on each device 112, 122 stores said unique identifier.

After the optional enrollment process, the process continues with the user 110 executing the application (such as on the device 112), so as to begin the process of engaging in a real time text conversation with another user 120. The user 110 issues an initiation command to the application via the graphical user interface (GUI) of the application, wherein the command may be given as described above. The application includes an initiation module for sending a validation request 202 to the server 102 over the communications network 106, such as via HTTP, in response to receiving the initiation command from the user 110 via the GUI of the application. The validation request 202 may include a unique identifier for the user 110.

A server application running on the server 102 receives the request 202. The server application running on the server 102 includes a validation module for receiving the validation request 202 from the mobile computing device 112 and, in response, looking up the user record of user 110 using the unique identifier in the request 202. Then, if and only if the server 102 finds the unique identifier, the server application accesses from the user record of user 110 a list of text message or chat partners or friends of said user 110, and generates a message 206 that includes the list of text message or chat partners or friends of said user 110, wherein each chat partner or friend may be identified in the message by any of the above information for a user record, such by name, address, telephone number(s), email address, a photograph, etc. In one embodiment, the current list of chat partners included in message 206 comprises only users that have previously already been validated by the server 102 (which occurs when the server 102 sends a user a validation in a response, such as responses 206 and 208, as described below).

Subsequently, the server application sends the message or response 206 to mobile computing device 112 over network 106, such as via HTTP, wherein the response 206 includes a validation (if and only if the server 102 finds the unique identifier provided in 202), which may comprise a unique code or set of computer instructions that indicates the request 202 has been validated. Then, the initiation module of the application running on computing device 112 receives the response 206 including the validation, as well as the current list of chat partners, from the server 102. In one embodiment, the server application on server 102 stores a value or data in memory or in the user record of user 110 in such a fashion that it indicates that user 110 has been validated. In this manner, the server 102 may later determine if user 110 is currently validated by checking said value or data in memory or database 104. When a chat or text messaging session has ended, said value or data may be erased or changed.

Similarly to user 110, the user 120 may execute the application on his computing device 122, which sends a request 204 to server 102. In response, the server 102 sends a response 208 (including a validation and a list of current chat partners of user 120) to device 122. In an optional step, the server 102 sends an updated list of current chat partners to either or both devices 112, 122 if the list of current chat partners has changed since the list was sent to the devices 112, 122. This may occur if a user becomes validated after a list of current chat partners is sent to a device.

Once the device 112 of user 110 receives response 206, the GUI of the application may display the current list of chat partners produced by server 102. This information may be displayed in a variety of ways, such as by displaying a list of names, photographs, phone numbers, etc. Subsequently, the user 110 is prompted, via the GUI of the application on his device, to select a recipient (such as user 120) from the list of chat partners displayed. The user 110 indicates his selection of one or more chat partners via the GUI of the application, wherein the selection or command may be given as described above.

The application of the computing device 112 further includes a transmission module for detecting the user 110's selection of the recipient 120 from the current list of chat partners, via the GUI. The transmission module further transmits a message 209, comprising an identification of the recipient 120 (such as an IP address, a unique identifier, a telephone number, etc.), to the server 102 over the communications network 106, such as via HTTP. The server application on server 102 receives the message 209 and stores the identification of the recipient 120 in memory or in the user record of user 110 in such a fashion that it indicates that users 110 and 120 are currently engaged in a real time text message chat.

The transmission module also detects the input of a single keyboard stroke by the user 110 in the GUI and transmits a message 210, including the keyboard stroke to the server 102 over the communications network 106, such as via HTTP, without requiring any command from the user 110 to send the keyboard stroke. That is, the transmission module sends each keyboard stroke it detects immediately to server 102. A keyboard stroke may comprise an alphanumeric character, a space, a newline, whitespace, a backspace, an emoticon, a cut action (wherein text is cut or copied to a clipboard), a paste action (wherein text is pasted as one or more keyboard strokes), or the like. The message 210 may also include the unique identifier for user 110.

The server application executing on server 102 further includes a message relay module for receiving the message 210 including the keyboard stroke and unique identifier, from the mobile computing device 112 over the network 106. In response, the server 102 looks up (in database 104 or in memory) the unique identifier provided by message 210. Recall that server 102 previously stored the identification of the recipient 120 in memory or in the user record of user 110 in such a fashion that it indicates that users 110 and 120 are currently engaged in a real time text message chat. Thus, the lookup action performed by server 102 results in the server 102 determining that the keyboard stroke in message 210 should be relayed to user 120.

Consequently, the server application on server 102 transmits a message 212 to mobile computing device 122 of user 120, wherein the message 212 includes the keyboard stroke that was included in message 210. Consequently, the application executing on the mobile computing device 120 includes a receiving module that receives the keyboard stroke and displays the keyboard stroke inline in the GUI of the mobile computing device 120. Since the keyboard stroke entered by user 110 in his device 122 was immediately transmitted to server 102, which immediately transmitted the keyboard stroke to device 122, which immediately displayed the keyboard stroke inline in the GUI of the device 120, the keyboard stroke was experienced in real time by the user 120. Displaying keyboard strokes inline refers to the practice of displaying each keyboard stroke one after another on the same line of text, including any alphanumeric character, a backspace, a space, a newline, whitespace, an emoticon, a cut action, a paste action, or the like. Displaying each keyboard stroke on different lines or separated by newlines or whitespace is not considered displaying a keyboard stroke inline.

Similarly, to the transmission of the message 210 from user 110, the application of the computing device 122 detects the input of a single keyboard stroke by the user 120 in its GUI and transmits a message 214, including the keyboard stroke, as well as a unique identifier, to the server 102, without requiring any command from the user 120 to send the keyboard stroke. Then, the server application executing on server 102 receives the message 214 and transmits a message 216 to mobile computing device 112 of user 110, wherein the message 216 includes the keyboard stroke. Consequently, the application executing on the mobile computing device 110 includes a receiving module that receives the keyboard stroke and displays the keyboard stroke inline in the GUI of the mobile computing device 110.

In one alternative embodiment, server 102 may perform an alternative process in lieu of the practice of server 102 receiving the message 209 and storing the identification of the recipient 120 in memory or in the user record of user 110 in such a fashion that it indicates that users 110 and 120 are currently engaged in a real time text message chat. In the alternative practice, when the application on device 112 receives the response 206, the application stores the unique identifiers for each chat partner. When the user 110 selects chat partner, the application on device 112 stores the unique identifier for said chat recipient. Then, the message 210 of user 110 also includes the unique identifier for said chat recipient. When server 102 receives said message 210, the server 102 looks up (in database 104 or in memory) the unique identifier of the chat recipient provided by message 210, so as to determine an address to which to send the message 212. This process can also be used to process messages from user 120 intended for user 110.

In one embodiment, data 304 corresponds to requests 204, 206, message data 306 corresponds to 209, 210, 214, response 308 corresponds to 206, 208 and message 310 corresponds to 212, 216.

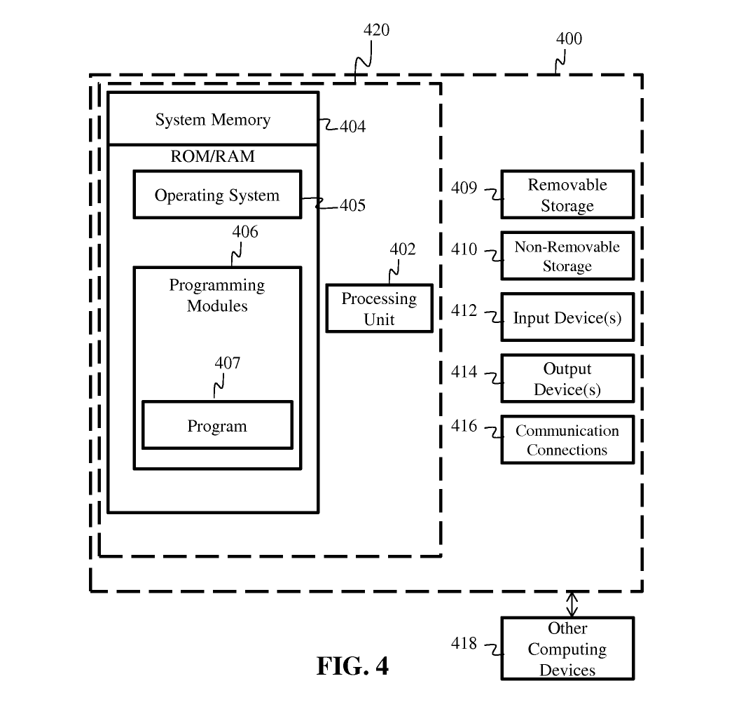

FIG. 4 is a block diagram of a system including an example computing device 400 and other computing devices. Consistent with the embodiments described herein, the aforementioned actions performed by 102, 112, 122 may be implemented in a computing device, such as the computing device 400 of FIG. 4. Any suitable combination of hardware, software, or firmware may be used to implement the computing device 400. The aforementioned system, device, and processors are examples and other systems, devices, and processors may comprise the aforementioned computing device. Furthermore, computing device 400 may comprise an operating environment for the methods shown in FIGS. 2-3 above.

With reference to FIG. 4, a system consistent with an embodiment of the invention may include a plurality of computing devices, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination or memory. System memory 404 may include operating system 405, one or more programming modules 406 (such as program module 407). Operating system 405, for example, may be suitable for controlling computing device 400's operation. In one embodiment, programming modules 406 may include, for example, a program module 407. Furthermore, embodiments of the invention may be practiced in conjunction with a graphics library, other operating systems, or any other application program and is not limited to any particular application or system. This basic configuration is illustrated in FIG. 4 by those components within a dashed line 420.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a camera, a touch input device, etc. Output device(s) 414 such as a display, speakers, a printer, etc. may also be included. The aforementioned devices are only examples, and other devices may be added or substituted.

Computing device 400 may also contain a communication connection 416 that may allow device 400 to communicate with other computing devices 418, such as over a network in a distributed computing environment, for example, an intranet or the Internet. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 404, including operating system 405. While executing on processing unit 402, programming modules 406 may perform processes including, for example, one or more of the methods shown in FIGS. 2-3 above. The aforementioned processes are examples, and processing unit 402 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A mobile text messaging application on a mobile computing device communicatively coupled to a communications network, comprising:
a graphical user interface for receiving input from a user of the mobile application;
an initiation module configured for:
receiving a command from the user via the graphical user interface, the command for sending a validation request to a central server;
sending a validation request to the central server over the communications network, in response to receiving said command, wherein said validation request includes a unique identifier for the user; and
receiving a validation, as well as a validated list of text messaging recipients, from the central server over the communications network, wherein each recipient in the validated list has received a validation, and wherein the validated list includes a unique identifier for each recipient;
a transmission module configured for:
receiving a selection from the user via the graphical user interface, the selection comprising one or more text messaging recipients from the validated list;
storing a unique identifier for each of the one or more text messaging recipients selected from the validated list;
detecting the input of a single keyboard stroke by the user in the graphical user interface and transmitting the keyboard stroke, as well as the unique identifier for the user and a unique identifier for each of the one or more text messaging recipients selected from the validated list, to the central server over the communications network, without requiring any command from the user to send the keyboard stroke; and
a receiving module configured for:
receiving a keyboard stroke from the central server over the communications network; and
displaying the keyboard stroke, and each subsequent keyboard stroke received, inline in the graphical user interface of the mobile computing device.

2. A server application on a server communicatively coupled to a communications network, comprising:
a validation module configured for:
receiving a validation request from a first mobile computing device over the communications network, responsive to the first mobile computing device receiving a command from a first user of the first mobile computing device via a graphical user interface to send a validation request, the validation request including a unique identifier for the first user;
performing a lookup in an attached database for a user record associated with the unique identifier and reading from said user record a list of text messaging recipients;
calculating which of said list of text messaging recipients are currently validated and generating validated list of text messaging recipients; and
sending to the first mobile computing device a validation, as well as the validated list of text messaging recipients, over the communications network, wherein each recipient in the validated list has received a validation, and wherein the validated list includes a unique identifier for each recipient; and
a message relay module configured for:
receiving a keyboard stroke, as well as one or more unique identifiers associated with one or more recipients, from the first mobile computing device over the communications network;
performing a lookup in an attached database for a user record associated with each recipient identified by said one or more unique identifiers and reading from said user record a recipient address; and
transmitting, over the communications network, the keyboard stroke to mobile computing devices identified by said recipient addresses, such that each recipient mobile computing device displays the keyboard stroke inline on the mobile computing device.
